(19) United States
(12) Patent Application Publication
(10) Pub. No.: US 2008/0213908 A1
(43) Pub. Date: Sep. 4, 2008

(54) FLAME DETECTOR

(75) Inventor: Kevin B. Thurbide, Calgary (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: UTI Limited Partnership, Calgary (CA)

(21) Appl. No.: 11/946,788

(22) Filed: Nov. 28, 2007

Related U.S. Application Data
(63) Continuation-in-part of application No. 11/019,107, filed on Dec. 22, 2004.
(60) Provisional application No. 60/582,549, filed on Jun. 25, 2004.

(51) Int. Cl. G01N 25/20

(52) U.S. Cl. 436/73; 422/51; 436/147; 436/103; 436/123; 436/145

(57) ABSTRACT

Improved operating modes of a micro counter-current flame ionization detector (μFID) are demonstrated. By operating the flame inside the end of a capillary gas chromatography (GC) column, the effective cell volume enclosing the flame is considerably reduced and results in significantly lower gas flows being required to produce optimal sensitivity from the stable flame. In a post-column μFID arrangement, a very lean flame is now situated on the end of a stainless steel capillary delivering 10 mL/min of hydrogen, which is opposed by a counter-current flow of only 20 mL/min of oxygen. The μFID detection limit obtained in this stable, oxygen-rich counter-current flame mode is 7×10⁻¹¹ gC/s with a response that is linear over 6 orders of magnitude. These findings are comparable to those of a conventional FID. Overall, the results indicate that the low-flow sensitive μFID operating modes presented demonstrate that this detector may be potentially useful for further adaptation to portable devices and related GC applications.

### CROSS-REFERENCE TO RELATED APPLICATIONS

This application is a continuation-in-part of U.S. patent application Ser. No. 11/109,017 filed Dec. 22, 2004, and claims the benefit under 35 USC 119(e) of U.S. Provisional Application No. 60/582,549 filed Jun. 25, 2004. Both of these applications are incorporated by reference herein in their entirety.

### FIELD AND BACKGROUND

An area of increasing development in the field of gas chromatography (GC) is instrument miniaturization. Notable examples of such advances include portable field GC units and GC separations achieved on a micro-analytical chip. In conjunction with these efforts, there is also a growing interest in developing sensitive miniaturized detection methods that can be incorporated into micro-analytical devices. A number of such miniaturized or ‘micro’ detection methods have been reported based on a variety of principles including surface acoustic wave transmission, thermal conductivity, and plasma-based optical emission. Although flame-based detectors are prevalent in many conventional GC applications, relatively few have been adapted to micro-analytical formats. Since the latter tend to utilize very small (nL range) channels, this may be partly attributed to difficulties encountered in operating a stable flame within these dimensions. In this regard, however, a very interesting and useful system has been successfully demonstrated. The method employs low gas flows to support a high energy premixed flame (about 3 mm tall×1 mm wide) that can perform atomic emission/hydrocarbon ionization detection on the surface of a micro-analytical chip.

The flame photometric detector (FPD) is a widely used GC sensor for determining sulfur, phosphorus, tin, and other elements in volatile organic compounds based on their chemiluminescence within a low-temperature, hydrogen-rich flame. We introduced a novel method of generating a similar flame environment using counter-flowing streams of gas [K. B. Thurbide, B. W. Cooke, W. A. Aue, J. Chromatogr. 1029 (2004) 193.]. This ‘counter-current’ FPD was demonstrated to provide similar sensitivity and response characteristics to that of a conventional FPD when operated in the hydrogen-rich mode. As well, it was also found to yield useful flame ionization detector (FID) signals when operated in the air-rich mode. Most notably, unlike a conventional FPD, this method produced remarkably stable flames at relatively low and high gas flows of varying stoichiometry. In fact, this aspect of the detector was employed in the primary focus of the study, which explored changes in transition metal response as a function of flame size derived from gas flows that differed by several hundred mL/min.

Subsequent to this work (but reported earlier) we exploited the great stability of counter-current flames in a new way by using them to create an enclosed hydrogen-rich micro-flame [K. B. Thurbide, C. D. Anderson, Analyst 128 (2003) 616]. The flame was supported on a fused silica capillary by only a few mL/min of gas flow and encompassed a very small volume of 30 nL. As well, it produced qualitatively similar response characteristics toward sulfur and phosphorus-containing analytes as that of a conventional FPD. The method was employed in a novel micro-Flame Photometric Detector (μFPD) which was operated either inside the end of a capillary gas chromatography column (on-column) or within a length of capillary quartz tubing after the separation column (post-column), with each mode displaying similar characteristics.

In general, the dimensions and qualities of the micro counter-current flame indicated that it could be a potentially useful method of producing chemiluminescent molecular emission, similar to a conventional FPD, within small channels and analytical devices of reduced proportions. However, unlike the larger counter-current flame, the primary disadvantage to the micro-flame method was the relatively large detection limits that it produced for sulfur and phosphorus due to an elevated background emission. The spectrum, intensity, and orange appearance of the emission indicated that the fused silica capillary burner was glowing from contact with the flame. Despite efforts to prevent this it was observed under all conditions investigated.

### SUMMARY

A flame detector is described in the parent application, which is U.S. Application Publication No. 2005/0287033 published Dec. 29, 2005 (the '033 Publication), in which a micro-flame detector is provided comprising a housing having an oxygen inlet, a hydrogen inlet, an analyte port and a flame region. A metal capillary delivers oxygen through the oxygen inlet to the flame region. The metal capillary has a melting point sufficiently high that glow emissions from the metal capillary during flame detection does not significantly interfere with detection. A hydrogen and analyte delivery system delivers hydrogen and analyte to the flame region. The flame detector may be operated in a photometric mode in which a photo-detector is arranged to detect flame emission through a flame detection port or an ionization mode in which an ionization detector is arranged to detect flame characteristics. In an embodiment, the metal capillary provides a flame stabilization surface for a flame less than 1 μL in volume. In another embodiment, the metal capillary is a stainless steel capillary. The hydrogen and oxygen may be provided in a countercurrent mode.

The results reported in the '033 publication for the μFID were generated as a by-product of the hydrogen-rich flame conditions designed to promote chemiluminescence and photometric detection of target analytes in the μFPD. The μFID may be used as an independent detector for use in GC. For example, the μFID may be operated inside the end of a capillary GC column. Subsequently, within similar greatly reduced dimensions, an oxygen-rich μFID operating mode is also disclosed where the micro counter-current flame is situated on the end of a hydrogen-delivering capillary immersed in an opposing excess oxygen flow.

Therefore, there is disclosed a micro-flame detector, comprising a first tube connected to an oxygen source and providing a flow path for oxygen towards a flame region; a second tube connected to a hydrogen source and providing a flow path for hydrogen towards the flame region; the first tube and second tube being arranged to provide counter-current flows of oxygen and hydrogen in the flame region; at least one of the first tube and the second tube being a metal capillary terminating at the flame region and having a melting point sufficiently high that glow emissions from the metal capillary during flame detection does not significantly interfere with detection; a source of analyte leading to the flame region; the metal capillary providing a flame stabilization surface for a flame less than 1 μL in volume; and at least a detector arranged about the flame region, the detector comprising at least one of an ionization detector and a photodetector. In one embodiment, the flame stabilizes on the hydrogen delivery tube, and in another embodiment, on the oxygen delivery tube. In a further embodiment, the flame is established immediately on top of a GC column. Methods of operating a micro-flame detector are disclosed. Various other embodiments are described below and claimed.

### BRIEF DESCRIPTION OF THE FIGURES

There will now be described preferred embodiments of the invention by reference to the figures, by way of illustration only, in which:

FIG. 1A is a schematic view of a micro-counter-current flame detector according to the invention;

FIG. 1B is a detail of the tip of the burner of FIG. 1A showing a flame;

FIG. 2 is a schematic illustration of an on-column μFID arrangement;

FIG. 3 shows a μFID response in an on-column mode toward various flows of carbon as benzene (▪), decane (□), cyclopentanol (▴), hexadecane (), and naphthalene (◯);

FIG. 4 shows a μFID chromatogram illustrating the peak profile obtained in an on-column mode for a 500 ng injection of cyclopentanol, in which oxygen flow is 4 mL/min and hydrogen flow is 10 mL/min;

FIG. 5 shows fast GC separation of an alkane mixture using elevated carrier gas flows in the on-column μFID mode, in which hydrogen flow is 84 mL/min and oxygen flow is 4 mL/min (initial column temperature is 100° C., increasing at 44° C./min upon injection, injected analyte amounts are about 1 μg each of decane, norpar (C₁₁-C₁₅), hexadecane, octadecane, and eicosane in carbon disulfide);

FIG. 6 is a schematic illustration of an inverted oxygen-rich μFID arrangement; and

FIG. 7 shows a μFID response in an inverted oxygen-rich mode toward various flows of carbon as tetradecane (▪), decane (□), benzene (), and naphthalene (◯).

### DETAILED DESCRIPTION

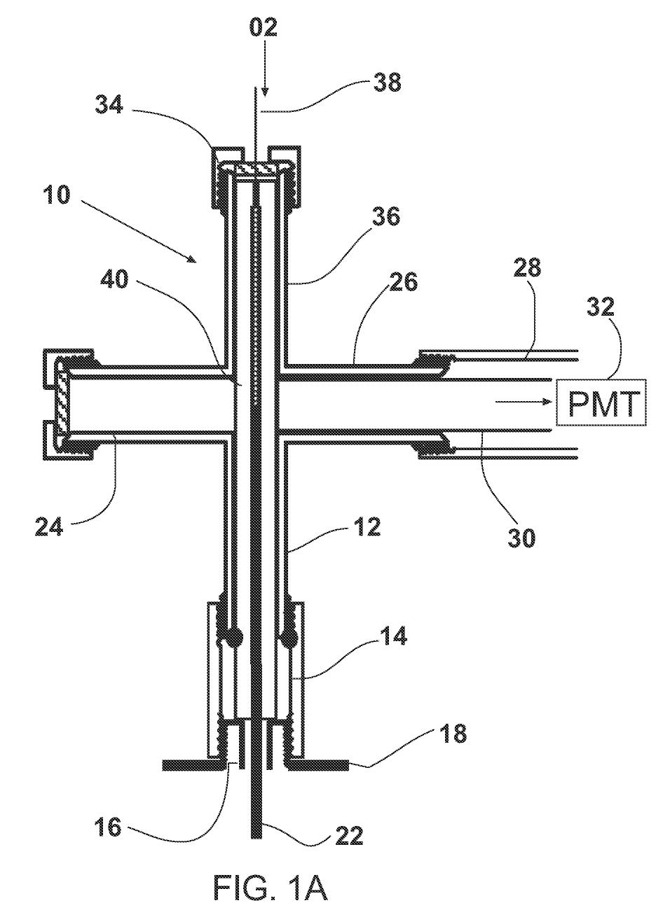

In this patent document, the word “comprising” does not exclude other elements being present and the use of the indefinite article “a” before an element does not exclude others of the same element being present. A flame photometric detector is considered to be a micro-flame detector, either μFID (ionization detector) or μFPD (photometric detector), if the flame volume, as defined by the visible boundary of the flame, is less than 1 μL (1×10⁻⁶ L), which for example is satisfied by spherical flame diameters of less than 1 mm. In particular, the μFPD shown in FIGS. 1A and 1B for which experimental results are described here produces a flame of approximately 30 nL in volume.

A micro-flame detector arranged for counter-current operation comprises a first tube connected to an oxygen source that provides a flow path for oxygen towards a flame region and a second tube connected to a hydrogen source that provides a flow path for hydrogen towards the flame region, the flows being opposite to each other in the flame region. At least one of the first tube and the second tube is a metal capillary that terminates at the flame region. The metal capillary has a melting point sufficiently high that glow emissions from the metal capillary during flame detection does not significantly interfere with detection. The flame region will typically be protected from interference from outside sources by for example being defined within a larger sleeve, for example made of quartz. The metal capillary should be small enough to provide a flame stabilization surface for a flame less than 1 μL in volume (the flame volume being defined by that portion of the flame that emits light in the visible spectrum). A source of analyte leads to the flame region, as for example a GC column. The analyte may also be provided through a separate tube, or through the hydrogen delivery tube or through the oxygen delivery tube, and need not be sourced from a GC column. A detector is arranged about the flame region to detect properties of the flame. For photodetector operation, a photodetector is arranged about the flame region, and for ionization detection, the collector of an ionization detector is arranged about the flame region.

FIG. 1A presents a simplified schematic illustration of an embodiment of a micro counter-current flame arrangement in a photometric detection mode. FIG. 1B shows a detail of the flame region of the μFPD, with connectors for μFID operation. In FIG. 1B, the oxygen supply tube 38 provides a flame stabilization surface. In FIG. 1A, either of the oxygen supply tube or the hydrogen supply tube could provide the flame stabilization surface, depending on flow rates of oxygen and hydrogen. In FIG. 1A, a housing 10 is conveniently made from a suitable material such as stainless steel cross union that encloses the micro-flame. The cross design permits monitoring of the flame. The bottom 12 of the housing 10 is connected to a length of stainless steel tubing 22 for the supply of hydrogen to the flame region 40 at the center of the housing 10. The housing 10 is secured via a union adaptor to a tube stub 16 that fits an FID detector base 18 of a Gas Chromatograph instrument. Hydrogen is introduced from a suitable source 23 and suitable ferrules are used to connect the hydrogen supply tubing 22 to, but prevent its direct contact with, the GC instrument or detector housing for the case of FID operation. A ferrule situated within the tube stub 16 is suitable for securing the tubing 22. A port 24, of the housing 10 may be used to visually align and monitor the micro-flame. Directly opposite to this, another horizontal port 26 is adapted with a threaded stainless steel tube 28 that encases a quartz light guide 30 which directs the flame emission to a photomultiplier tube 32.

FIG. 1B shows a detail of a flame region that may be used in the embodiment of FIG. 1A. A quartz capillary sleeve 33 extends vertically from bottom port 12 through to top port 36. In the lower port 12, the capillary sleeve 33 surrounds the hydrogen sleeve 22 and a capillary GC column 20 that functions as a source of analyte. Hydrogen may also be introduced through the GC column. Above the lower port 12, in the flame region 40, the capillary sleeve 33 conducts the hydrogen and column effluent (analyte plus carrier) from capillary sleeve 22 towards the flame 42. Through a septum 34 in the top port 36, a length of stainless steel capillary tubing 38 carrying oxygen from a source 39 extends downward into the quartz sleeve 33 to the center 40 of the union 10, directly in front of both the light guide port 26 and the viewing port 24. Under typical operating conditions in one embodiment, the micro-flame 42 is situated on the end of this oxygen capillary 38 burning ‘upside down’ within a counter flowing stream of hydrogen and column effluent from the bottom. The arrangement for delivering hydrogen and analyte may be varied considerably from what is described here. A tube in tube arrangement with hydrogen in the annulus between the tubes may be used as described here. Also, hydrogen may be supplied through a capillary column 20 along with the analyte. Other arrangements will occur to a person skilled in the art. High purity helium, hydrogen, and oxygen may be obtained from any suitable source.

The separation column 20 extends vertically upward from the GC instrument and into the detector housing 10 through the connecting stainless steel tube 22 carrying the hydrogen. Typical separations employ 5 mL/min of helium as the carrier gas. In an embodiment, about 1-3 mm separates the end of the column 20 from the oxygen burner 38. For μFID experiments, electrical leads from a gas chromatograph (GC) are used such that the polarizer 44 of the GC is connected to the stainless steel oxygen burner 38 and the collector 46 is connected to the stainless steel hydrogen tube 22 surrounding the separation column 20.

Stainless steel is an improvement over fused silica because it has a higher heat capacity. As such, the heat of the flame does not cause it to glow from being incandescently heated. Glowing creates a large background response in the detector, which decreases its sensitivity. The improvement offered by stainless steel includes improved detection limits and the simultaneous FID method, and allow the method to be useful in more situations. In addition to a stainless steel capillary, the flame could also be supported on other metals that have a sufficiently high melting point, such as nickel, or some alloys. Typical flame volume for the stainless steel shown in FIGS. 1A and 1B with dimensions as disclosed in the '033 publication was about 30 nL.

To light the device, the oxygen containing capillary 38 is drawn through a flame, ignited, and is pushed into the hydrogen stream, keeping it lit. The original flame either extinguishes or can be blown out like a candle. Once lit, the flame 42 generally stays stable for hours. Use of pure oxygen is preferred as a supply of oxygen. Various flow rates may be used depending on the arrangement. Thus, in one embodiment described in the '033 publication, a lower hydrogen limit measured was 6 mL min⁻¹ using 2 mL min⁻¹ of oxygen while the upper hydrogen limit measured was 113 mL min⁻¹ using 5 mL min⁻¹ of oxygen. In the embodiment disclosed in the '033 publication, the optimal flow region for operation was found to be in the area of 6 mL min⁻¹ of hydrogen and 2 mL min⁻¹ of oxygen. This flow region did not display any signs of flame instability and was typically operated daily for over 8 h with no degradation in performance. Lower gas flows than 6 mL min⁻¹ of hydrogen and 2 mL min⁻¹ of oxygen are also believed to provide flame stability.

Stainless steel capillary tubing of 0.01″ i.d., (0.018″ o.d., wall thickness of 0.004″) used as a burner 38 in the example of FIGS. 1A and 1B provided reduced background emission as compared with a smaller tubing. Using stainless steel the optimum μFPD response for sulfur was obtained with 7 mL/min of oxygen and 45 mL/min of hydrogen, while that for phosphorus was obtained when using 9 mL/min of oxygen and 58 mL/min of hydrogen. Various compounds may be studied with the device of FIGS. 1A and 1B such as carbon, as for example in hydrocarbons, tin, sulphur and phosphorous. Optimum signal to noise ratios for tin were obtained using 10 mL/min of oxygen and 25 mL/min of hydrogen. These μFPD conditions provide sensitive response yielding a detection limit near 6×10⁻¹⁵ gSn/s. Thus, the μFPD appears capable of yielding quartz surface emission that is sensitive toward picogram quantities of tin compounds. However, it is unclear why the detector currently displays saturation at such low analyte levels. Regardless, until further improvements can be realized, the narrow linear range of tin response offered by the μFPD makes it impractical as a tool for routine organo-tin analysis.

The use of a stainless steel capillary burner 38 makes it very convenient to apply a potential across the flame using the existing FID electrical leads of a GC, as for example by applying the polarizer 44 to the capillary burner 38 and the collector 46 to the stainless steel sleeve 22 surrounding the end of the separation column. In the ionization configuration, when the capillary burner was new, about 12 mL/min of oxygen was found to provide the best sensitivity. However, after a few hours of conditioning, this value decreased and stabilized at lower flows. Ultimately, the optimum gas flows for the “μFID” response mode of this flame toward carbon were obtained using 7 mL/min of oxygen and 40 mL/min of hydrogen. As disclosed in the '033 publication, the FID configuration of the device shown in FIGS. 1A and 1B showed sensitivity toward carbon as both decane and benzene under optimum conditions. Significant ionization and chemiluminescent signals can both be obtained from the same micro counter-current flame, including screening a multi-component mixture such as unleaded gasoline for its carbon, sulfur, and phosphorus content.

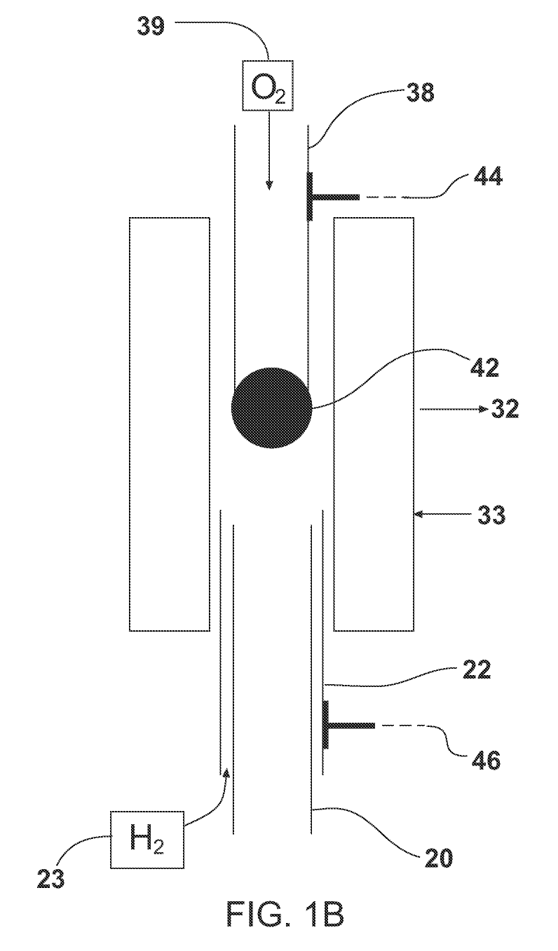

FIG. 2 shows an on-column FID mode of operation of a micro-flame detector, in which an oxygen delivery tube 52 is a stainless steel capillary oxygen burner supplied by an oxygen source 54. The tube 52 may have dimensions similar to the dimensions of tube 38. The tube 52 is inserted into the end of a capillary GC column 56, which may be a retro-fit into an existing GC or a newly designed GC. In the case where the tube 52 is retro-fit to an existing GC, such as a Shimadzu model GC-8A; Shimadzu, Kyoto, Japan, the column 56 extends about a few millimeters out from the original FID detector port of the GC. FID electronics 62 are connected between a polarizer 58 and a collector 60. In the case of a retro-fit, the electrical connections may be made with the original FID electrical leads of the GC. In this example, the polarizer 58 is connected to the flame-bearing oxygen burner 52, while the collector 60 is attached to a piece of steel wire 64 that is coiled and centered about the outlet 66 of the column 56. In the experiments described below, the steel wire 64 was 0.508 mm O.D. with ˜10 winds; each 5 mm O.D. The collector 60 of an FID may take many configurations, and be located in different positions about the flame region, so long as ions from the flame region can be sensed by the collector 60. To facilitate maintaining electrical insulation between the polarizer 58 and the collector 60, an insulating sleeve (not shown) such as 2 cm fused silica tubing, may be placed around the stainless steel capillary 52 to prevent it from contacting the coils 60 near the column outlet 66. Hydrogen from source 68 may be used as the carrier gas for analyte in this mode. With opposing flows from the tube 52 and tube 56, a flame 70 may be established on the oxygen tube 52 in a flame region 72 within the column 56.

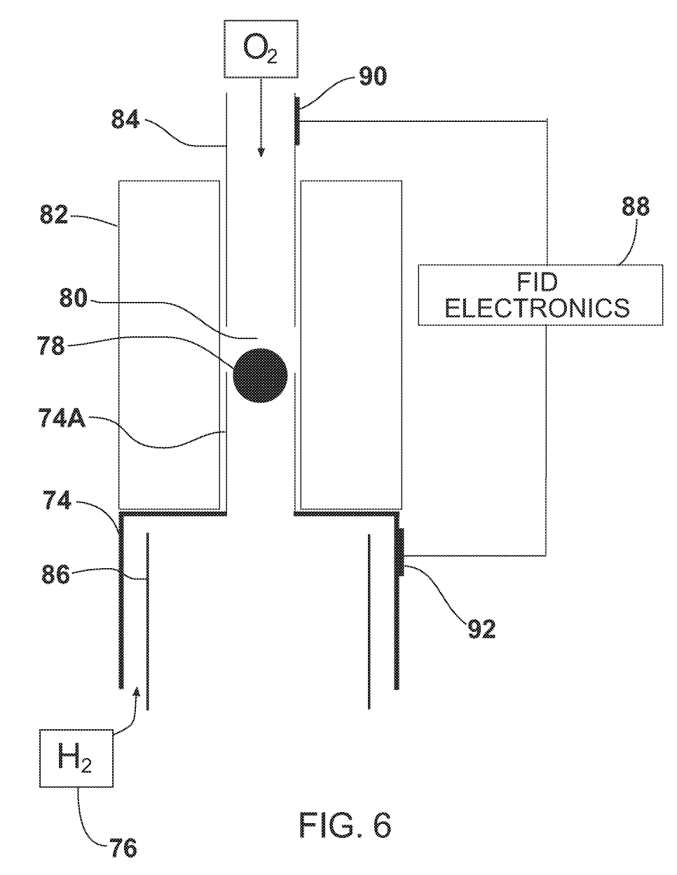

FIG. 6 shows an example of a micro-flame detector in which a hydrogen supply tube 74 connected to a hydrogen supply 76 is used to provide a flame stabilization surface for a flame 78 in a flame region 80 bounded by a sleeve 82, for example a quartz or Pyrex™ sleeve. An oxygen supply tube 84 terminates in the flame region 80. Analyte is sourced from a capillary GC column 86.

In the example shown in FIG. 6, the capillary GC column 86 of a conventional GC is inserted into the hydrogen supply tube 74 so that hydrogen is supplied through the annulus between the column 86 and the tube 74. In the example used for the experiments reported here, the tube 74 has sections with two diameters, the first section taking the form of a 2 cm length of a machined stainless steel tube stub (6.35 mm O.D.×1 mm I.D.) and the second section being a 5 mm length of stainless steel tubing 74A (0.508 mm O.D.×0.254 mm I.D.) centered on the tube stub. The second section 74A terminates in the base of sleeve 82 (in this example a tube having 5 cm×5 mm O.D.×0.55 mm I.D.). The tube stub of the hydrogen supply tube 74 is connected to a detector port of the GC using a Vespel ferrule (not shown) to electrically isolate it from the GC. The use of the second section 74A allows hydrogen to flow concentrically around the column 86 and mix with the effluent prior to emerging from the hydrogen tube 74. The sleeve 82 is secured gas tight to the body of the hydrogen tube 74, as for example using Teflon™ tape. The electrical leads of FID electronics 88 may be attached so that the oxygen tube 84 becomes the polarizer 90 and the hydrogen tube 74 is the collector 92. Other configurations of polarizer 90 and collector 92 may be used to obtain an ionization signal from the flame region 80 but this arrangement makes use of conveniently existing connections. The oxygen and hydrogen delivery tubes 84, 74 are separated approximately 1-2 mm inside the sleeve 82 during operation for the experiments described below. To avoid frequent replacement, the sleeve 82 should be a material that resists cracking and bubbling of the glass that may occur after extended periods of usage. Quartz is preferred, but other materials may be used such as Pyrex™. Helium is used as the carrier gas in this mode.

### Experimental

For the results described below, test analytes used for calibrations and applications are benzene (99%; EM Science, Gibbstown, N.J., U.S.A.), decane (99%; BDH Lab Supplies, Toronto, Canada), cyclopentanol (99%; Matheson Coleman & Bell, Cincinnati, Ohio, USA), naphthalene (99%; Fisher Scientific Company, Fair Lawn, N.J., USA), and tetradecane, hexadecane, octadecane, and eicosane (each 99%; Aldrich, Oakville, Canada). A commercial Norpar paraffin distillate (undecane (1%), dodecane (19%), tridecane (47%), tetradecane (32%), and pentadecane (1%)) acquired from the Petroleum Engineering Department on campus is also employed in some demonstrations. Samples were made by dissolving varying concentrations of the desired solutes in either acetone (99.5%, EMD Chemicals, Gibbstown, N.J., U.S.A.), carbon disulfide (99%; EMD chemicals), or hexane (analytical reagent; BDH Lab Supplies). Finally, a BTEX mixture (benzene (185 ng/μL), toluene (186 ng/μL), ethyl benzene (196 ng/μL), and xylenes (396 ng/μL meta/para combined, and 200 ng/μL ortho)) is also used as obtained from Dow Chemical (Fort Saskatchewan, Canada). Separations are performed on an EC-5 [(5%-phenyl)-95% methylpolysiloxane] megabore column (30 m×0.53 mm I.D.; 1.00 Mm thick, Alltech, Deerfield, Ill., USA) and normally use approximately 5 mL/min of high purity helium (Praxair, Calgary, Canada) as the carrier gas. High purity hydrogen (Praxair) is used as the flame fuel gas and, in some experiments, also the carrier gas. Medical-grade oxygen (Praxair) is used as the flame oxidant gas. Flow rates are discussed in the text.

### Results and Discussion

An on-column μFID arrangement used for the results described here is depicted in FIG. 2. The stainless steel capillary oxygen burner 52 polarizes the flame inside the GC column 56. The column outlet 66 by being larger than the burner 52 provides an exhaust outlet for the flame 70.

For the results described here, used with a retrofitted GC, the flame 70 was slowly moved along the inner wall of the GC column outlet 66 in order to burn off carbonaceous stationary phase and prevent it from interfering with the μFID response. An outer polyimide coating was also removed in this process. The flame 70 may be established at various levels within the GC column outlet 66, and in the case of a retro-fit, a sufficient distance from column coating to avoid further combustion of stationary phase, as for example 2.5 mm ahead of the remaining GC column coating. While the flame could be easily positioned at any depth inside of the GC column 56, it may for example be situated about 5 mm (>10 flame diameters) inside the outlet. This ensured that the flame 70 was completely enclosed on all sides and that all of the column effluent was directed through it. This position was also optimal in keeping the flame 70 in reasonable proximity to the collector 62 coiled around the column outlet 66. Minimizing this distance was essential to operation of this specific embodiment since preliminary trials using a BTEX sample indicated that too great of a flame-collector gap was observed to cause the μFID signal intensity to approach zero and the reproducibility to degrade significantly (e.g. from ˜2% to over 17% RSD). A collector that is located too far from the flame region is thus non-functional as an FID detector, and it is assumed, when a detector is referred to, that it is located in sufficient proximity to the flame region 72 to detect a signal.

In optimizing the flame gas flows for carbon response, for the specific embodiment shown, it was found that the hydrogen fuel/carrier gas needed to be above 8 mL/min to facilitate separation, even though lower hydrogen flows could readily support a stable flame. Optimal conditions will depend on the specific embodiment used, but for the design of FIG. 2, the optimal conditions in this mode were obtained using about 10 mL/min of hydrogen and 4 mL/min of oxygen, much lower than as used for the embodiment of FIGS. 1A and 1B, due to operating the micro counter-current flame 70 within the much more confined space of a capillary GC column 56. Oxygen flow rate is a function of burner tubing I.D., while optimal hydrogen flow is directly proportional to the sleeve diameter. Flow limitations for effective separations limit the lower extent of hydrogen flow, so that employing even narrower tubing for both the capillary GC column 56 and the oxygen burner 52 are expected to lead to further reductions in optimal gas flows.

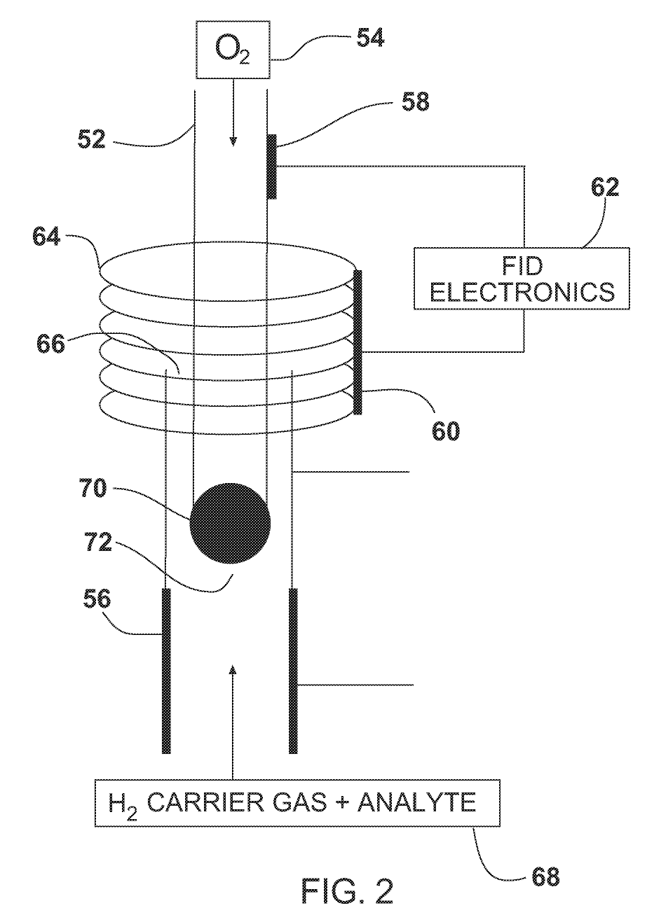

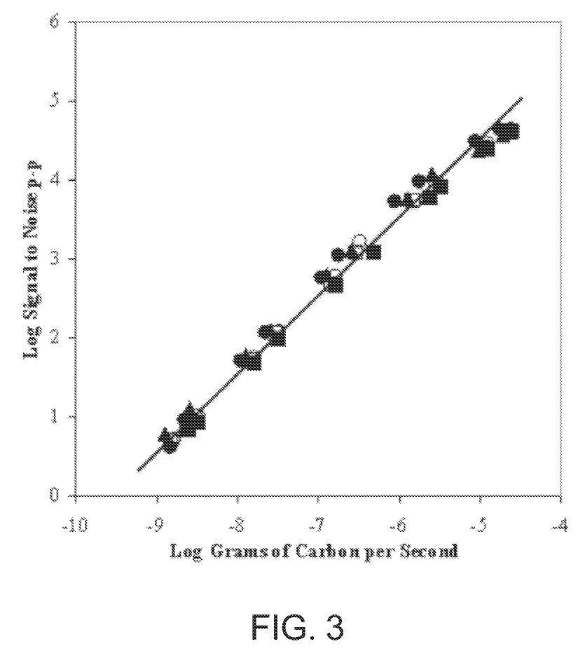

FIG. 3 shows the μFID response to different flows of carbon under the optimum conditions in the on-column mode of FIG. 2. The μFID yields a linear response over about 5 orders of magnitude and a minimum detectable limit (MDL) of approximately 6×10⁻¹⁰ gC/s (S/Nₚ₋ₚ=2). Further, the response is quite uniform amongst the various hydrocarbons investigated, which is also consistent with earlier work that found a similar response equimolarity between the μFID and a conventional FID. Thus, good performance and stability can be obtained using considerably lower optimal gas flows when the μFID is operated inside of a capillary GC column FIG. 4 illustrates the steady response typically observed in this mode for a sample injection of cyclopentanol.

The findings above suggest that a dedicated on-column μFID format should offer some potential advantages in certain GC applications. For example, its compact enclosure could minimize the spatial requirements of an on-board detector in micro-analytical devices that are constrained by extremely small dimensions. Additionally, the reduced gas flow requirements could increase operating lifetimes and decrease the amount of portable supply gas needed in field trials. Alternatively, the on-column μFID mode may also be useful in high speed GC separations, which often similarly employ hydrogen as the carrier gas through a capillary column. For example, it could further reduce supply gas requirements by eliminating the need for large makeup gas flows that are normally used in these methods to minimize critical extra-column peak broadening occurring en route to the detector. However, with respect to the latter application, it is worthwhile to also briefly address some other μFID properties relevant to its adaptability in this regard.

The conventional FID is widely used in fast GC applications partly due to its rapid response, which allows it to effectively profile the relatively narrow peaks generated by these techniques. As part of the current study, the detector time constant of an on-column μFID, a post-column μFID, and a conventional FID were estimated and compared using standard protocol. In fact, little difference was observed in the values obtained, which were all within the low millisecond range similar to that reported for a conventional FID. Another favorable property of the conventional FID in this area is its sturdy flame operation in the presence of high carrier gas flow rates, which are also frequently used in fast GC separations. Similar to earlier counter-current flame studies, it was additionally found in this work that the μFID flame also remains very stable as carrier gas flow rates are increased from relatively small to very large values. For example, using only 4 mL/min of oxygen, the on-column μFID could readily function with hydrogen flow rates of over 100 mL/min. Comparable results were also obtained when using helium as the carrier gas in a post-column μFID configuration. Thus, despite the different size and nature of their respective counter-current and diffusion flames, no difference in response time or flame stability is to be expected between the μFID and a conventional FID in such applications.

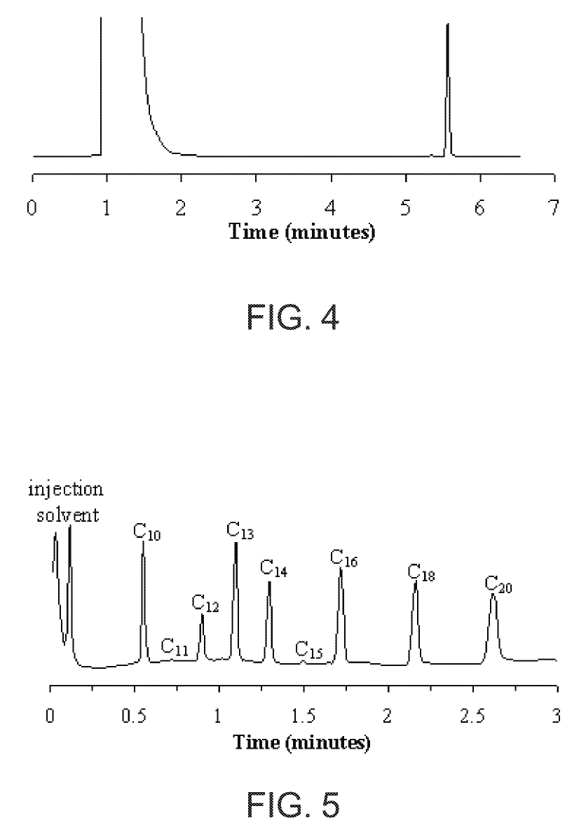

FIG. 5 demonstrates the on-column μFID mode employed in a fast alkane separation, which was achieved using hydrogen flow rates nearly ten times in excess of the optimum value. As seen, a stable detector response is provided at the elevated flows, although its magnitude is reduced (˜15 fold) under these accelerated unoptimized conditions. While the analyte peak half-widths produced in this sample separation (˜1 to 3 seconds) coincide with formal designations of fast GC, it should be recognized that much narrower peaks are certainly possible with other denoted methods of very fast or ultra fast GC. Thus, although in principle the μFID should be readily inserted in applications using a conventional FID, the actual extent to which the μFID could be useful in extremely fast separations would need to be further established under more appropriate conditions employing faster detector electronics. Still, the above findings do further support the potential of an on-column micro counter-current flame-based detection approach for high speed GC.

Although the on-column μFID mode provides a favorable flame size and stability using relatively low gas flows, its response characteristics are the same as those of the original device disclosed in the '033 publication. This is because the on-column μFID is still maintaining a slightly hydrogen-rich micro counter-current flame, as opposed to the largely oxygen-rich diffusion flame of a conventional FID. In optimizing the on-column μFID mode, it was found that using even larger flows of oxygen lifted the flame off of the capillary burner and dramatically decreased the response due to ineffective flame polarization. Thus, it was decided that it would be interesting to utilize the small dimensions of the on-column format but in a post-column μFID device. The anticipation was that this might enable the use of similar reduced gas flows while also allowing, for the first time, an oxygen-rich micro counter-current flame to be operated in attempts to improve sensitivity.

### Inverted Oxygen-Rich μFID Mode

Previous work with much larger counter-current flames has shown that stability can be maintained over a wide range of flame stoichiometry when using opposing burner arrangements. For example, in this larger format the flame normally resides on the burner delivering the limiting reagent gas, where under stoichiometric conditions it often hovers between the burners without making contact. However, previous attempts to operate an oxygen-rich micro counter-current flame in the dedicated μFPD arrangement was noted to result in unstable conditions due to the burner and quartz sleeve used. Therefore, this was expanded upon in the current study.

As shown in FIG. 6, a post-column μFID cell was fashioned such that two opposing metal capillaries 74, 84 were snugly secured inside of a glass tube 82 of similar diameter to the capillary GC column 86 used. In this arrangement, hydrogen and oxygen could flow counter-current to one another while still allowing the flame to be polarized at either burner 74, 84 depending on the stoichiometry established. When using this configuration hydrogen-rich as above, it was found that further increasing the oxygen flow again caused the flame to lift off of the stainless steel capillary burner 84 and the ionization response to seriously diminish. However, as more oxygen was added, the flame continued migrating until it ultimately resided on the lower hydrogen burner 74 and the response returned. In this arrangement then, the micro counter-current flame now operates oxygen-rich in an ‘inverted’ fashion, where the flame burns in an opposing excess flow of oxygen rather than hydrogen. Due to the compact design of this mode, the oxygen-rich μFID flame produced is also now observed to be very stable.

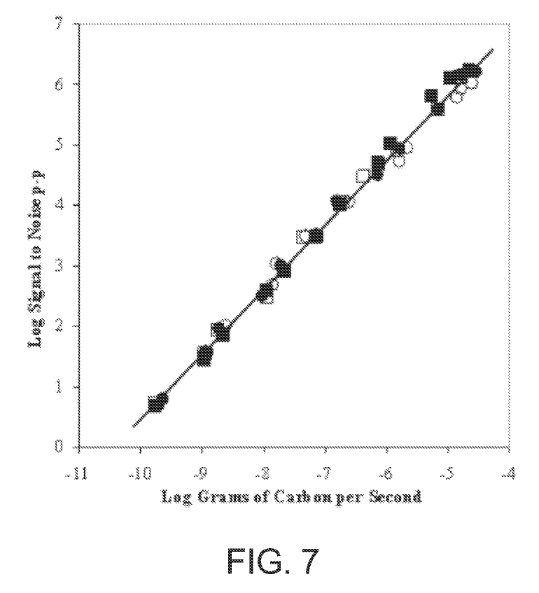

Since the flame enclosure was about the same diameter as the on-column mode, the optimal hydrogen flow rate in the inverted mode of FIG. 6 was again observed to be 10 mL/min, whereas that of oxygen was now decidedly in excess at 20 mL/min. These flows provide a flame environment that is similar to that of a conventional FID. For example, the optimal oxygen/hydrogen ratio used here is 2, which is very near to that used in conventional FID applications in our own laboratory and others. However, the overall flame gas flow rate employed in this inverted μFID mode is about 3 to 5 times lower by comparison. As shown in FIG. 7 under the optimum conditions above, the μFID response toward various flows of carbon is again reasonably uniform but is now linear over 6 orders of magnitude and generates an MDL of about 7×10⁻¹¹ gC/s. These values are much improved relative to previous μFID data and more comparable to a conventional FID. Thus, the oxygen-rich micro counter-current flame does significantly enhance μFID response.

The on-column and inverted μFID operating modes developed and investigated in this study further demonstrate that stable, low-flow micro counter-current flames of varying stoichiometry can be established within small enclosures and can produce valuable μFID response. While the findings indicate that further reductions in the size of the burner and flame enclosure might lead to even lower operating gas flows, the impact of such an endeavor on flame stability and response remains unknown. In general, therefore, despite the minuscule unique structure of the counter-current flame, the overall results from using this approach indicate that response characteristics similar to those of larger analog GC detector flames can be obtained by this method. As such, these properties suggest that the developed micro counter-current flame detection method may be useful for adaptation to portable and micro-analytical GC applications.

The apparatus and method disclosed here should also act as a useful flame source to support and adapt other micro-flame based detection methods such as Alkali Flame Detection. The apparatus and method disclosed also have utility in refinery and hydrocarbon processing plants for example in online applications. In addition, by adjusting the flow rate of hydrogen and oxygen, the flame may be made to stabilize between the oxygen delivery tube and the hydrogen delivery tube. In this case, the tubes define a flame stabilization region between them, and in order to provide a useful signal, depending upon the detection system used, the flame should be polarized by other means, such as by using a separate electrode (not shown) extending into the flame region. In cases where the flame is stabilized between the burners and separated from the burners, but not touching either burner, a metal capillary need not be used, and both burners may for example be made of glass. While embodiments have been disclosed in which counter-current flows are directly opposed to each other, counter-current flows may also be offset from direct opposition, providing the lateral flow of gas induced by the offset does not de-stabilize the flame. Further, while pure oxygen is preferred, the oxygen flow, and also the hydrogen flow, may include other gases providing the flow is sufficient to produce a flame without significantly degradating the signal from the flame emission.

Immaterial modifications may be made to the embodiment of the invention described here without departing from the invention.

What is claimed is:

1. A micro-flame detector, comprising:
a first tube connected to an oxygen source and providing a flow path for oxygen towards a flame region;
a second tube connected to a hydrogen source and providing a flow path for hydrogen towards the flame region;
the first tube and second tube being arranged to provide counter-current flows of oxygen and hydrogen in the flame region;
at least one of the first tube and the second tube being a metal capillary terminating at the flame region and having a melting point sufficiently high that glow emissions from the metal capillary during flame detection does not significantly interfere with detection;
a source of analyte leading to the flame region;
the metal capillary providing a flame stabilization surface for a flame less than 1 μL in volume; and
at least a detector arranged about the flame region, the detector comprising at least one of an ionization detector and a photodetector.

2. The micro-flame detector of claim 1 in which the first tube provides the flame stabilization surface.

3. The micro-flame detector of claim 2 in which the source of analyte is a gas chromatograph column.

4. The micro-flame detector of claim 3 in which hydrogen is supplied through the gas chromatograph column.

5. The micro-flame detector of claim 3 in which the detector is an ionization detector.

6. The micro-flame detector of claim 3 in which the first tube terminates inside the gas chromatograph column.

7. The micro-flame detector of claim 6 in which the detector is an ionization detector.

8. The micro-flame detector of claim 7 in which hydrogen is supplied through the gas chromatograph column.

9. The micro-flame detector of claim 1 in which the detector is a photodetector.

10. The micro-flame detector of claim 2 in which the first tube is a stainless steel capillary.

11. The micro-flame detector of claim 1 in which the second tube provides the flame stabilization surface.

12. The micro-flame detector of claim 11 in which the source of analyte is a gas chromatograph column.

13. The micro-flame detector of claim 12 in which hydrogen is supplied by a tube surrounding the gas chromatograph column.

14. The micro-flame detector of claim 13 in which the detector is an ionization detector.

15. The micro-flame detector of claim 14 in which the flame region is defined by a third tube inside of which third tube the first tube and second tube terminate.

16. The micro-flame detector of claim 11 in which the detector is an ionization detector.

17. The micro-flame detector of claim 11 in which the detector is a photodetector.

18. The micro-flame detector of claim 11 in which the second tube is a stainless steel capillary.

19. A method of detecting an analyte using a micro-flame detector, the method comprising the steps of:
stabilizing a flame in a flame region between burners in counter-current flows of oxygen and hydrogen, the flame having a volume less than 1 μL and being separated from the burners;
supplying analyte to the flame region; and
detecting flame emission from the flame using at least one of an ionization detector and a photo-detector.

20. A method of detecting an analyte using a micro-flame detector, the method comprising the steps of:
stabilizing a flame in a flame region in counter-current flows of oxygen and hydrogen, the flame having a volume less than 1 μL;
the flame being stabilized on the end of a metal capillary arranged for delivering one of oxygen and hydrogen to a flame region of the micro-flame detector;
the metal capillary having a melting point sufficiently high that glow emissions from the metal capillary during flame detection does not significantly interfere with detection;
supplying analyte to the flame region; and
detecting flame emission from the flame using at least one of an ionization detector and a photo-detector.

21. The method of claim 20 in which the analyte is supplied through a gas chromatograph column that terminates at the flame region.

22. The method of claim 20 in which the analyte is one or more of sulphur, phosphorus, tin and carbon.

23. The method of claim 22 in which hydrogen is supplied to the flame region at a gas flow rate of about 6 mL min⁻¹ and oxygen is supplied to the flame region at a gas flow rate of about 2 mL min⁻¹.

24. The method of claim 20 in which hydrogen is provided in stoichiometric excess of oxygen.

25. The method of claim 20 in which oxygen is provided in stoichiometric excess of hydrogen.

26. The method of claim 20 in which hydrogen is supplied to the flame region at a gas flow rate of between about 6 mL min⁻¹ and 113 mL min⁻¹ and oxygen is supplied to the flame region at a gas flow rate of between about 2 mL min⁻¹ and 20 mL min⁻¹.

27. The method of claim 20 in which detection of flame emission is carried out by ionization detection.

28. The method of claim 20 in which the metal capillary delivers oxygen to the flame region.

29. The method of claim 20 in which the metal capillary delivers hydrogen to the flame region.

30. The method of claim 20 in which hydrogen is supplied to the flame region at a gas flow rate of 10 mL min⁻¹ and oxygen is supplied to the flame region at a gas flow rate of 20 mL min⁻¹.

31. A method of operating a micro-flame detector, where the micro-flame detector comprises a first tube connected to an oxygen source and providing a flow path for oxygen towards a flame region, a second tube connected to a hydrogen source and providing a flow path for hydrogen towards the flame region, the first tube and second tube being arranged to provide counter-current flows of oxygen and hydrogen in the flame region to produce a flame less than 1 μL in volume, a source of analyte leading to the flame region, and at least a detector arranged about the flame region, the detector comprising at least one of an ionization detector and a photodetector, the method comprising the steps of adjusting oxygen and hydrogen flows so that a flame stabilizes in the flame region between the first tube and the second tube.

32. The method of claim 31 in which at least one of the first tube and the second tube is a metal capillary terminating at the flame region and have a melting point sufficiently high that glow emissions from the metal capillary during flame detection does not significantly interfere with detection.
